(19) United States
(12) Patent Application Publication
(10) Pub. No.: US 2009/0214695 A1
(43) Pub. Date: Aug. 27, 2009

(54) Feeding Stuff Composition Comprising Proliferation Promoting Agent for Bifidus Bacteria and Use of the Same

(75) Inventors: Yoshihito Hagawa, Nerima-ku (JP); Nobuo Yoda, Koto-ku (JP); Takenori Orihashi, Mito-shi (JP); Michio Kanbe, Higashimurayama-shi (JP)

Correspondence Address: EDWARDS ANGELL PALMER & DODGE LLP, P.O. BOX 55874, BOSTON, MA, 02205, US

(73) Assignees: Meiji Feed Co., Ltd., Tokyo (JP); Meiji Dairies Corporation, Tokyo (JP)

(21) Appl. No.: 11/886,678

(22) PCT Filed: Mar. 17, 2006
(86) PCT No.: PCT/JP2006/305448

§ 371 Date: Feb. 17, 2009

(30) Foreign Application Priority Data
Mar. 18, 2005 (JP) 2005-079168

(51) Int. Cl. A23C 21/02; A23K 1/18

(52) U.S. Cl. 426/2; 426/61

(57) ABSTRACT

The present invention relates to a feed composition comprising milk whey fermented by Propionibacterium and a method for forming and/or establishing a Bifidobacterium flora in an intestine of a newborn domestic animal, which comprises administering the feed composition to the newborn domestic animals.

### TECHNICAL FIELD

Present invention relates to a feed composition and use thereof and, more specifically, to a feed composition for a newborn domestic animal, particularly for a calve, shortly after the birth and a use thereof. The feed composition according to the present invention has an intestinal flora improvement activity and is usable for milk replacer and a mixed feed for calves. It is possible to create a flora which is abundant with Bifidobacterium by administering the feed composition of the present invention to a newborn animal immediately after the birth of the newborn domestic animal.

### BACKGROUND ART

It is not easy to steadily promote a growth of a domestic animal even when the domestic animal is an adult, and the growth promotion of a newborn domestic animal that is inferior in physical capacity and delicate is difficult. For example, in the case of a newborn calf, factors inhibiting the growth include insufficient colostrum ingestion, inappropriate environment (poor hygiene), change in feed, change from maternal milk to artificial feed (milk replacer, starter, or the like), stresses caused by transportation and change in breeding environment, and the like.

In the intestine of a healthy animal, a certain number of resident intestine microbiota is present on the intestinal mucosa to prevent infection with various pathogens. On the other hand, a balance in an intestinal flora is disturbed by changes in feed and environment, stress, administration of antibiotics, and the like. For example, there is a report that either of Lactobacillus or Bifidobacterium is reduced in calves suffering from diarrhea, and an importance of the useful bacterium is pointed out.

The calf intestinal flora is rapidly formed after the birth. It is desirable that a normal flora which is abundant with Bifidobacterium is formed and is maintained through and after a weaning period. However, actually, there are many inhibitory factors which affect the flora in actuality. For example, the colostrum is replaced by milk replacer 4 to 7 days after the birth, and diarrhea tends to occur.

After that, calves are transported to breeding farms from their birth places.

Since calves have poor adaptability to a change in feed, an increase in feed amount, transportation, and environmental stress, the intestinal flora which is insufficient in stability is influenced.

Additionally, the intestinal flora is disturbed by a weakened immune system due to insufficient colostrum, stress due to transportation and environmental change for calf introduction, a change in feed, and the like to cause the diarrhea.

The diarrhea occurring during a suckling period causes a growth stagnation that is a cause of adverse effects on the subsequent growth.

Hereinafter, specific examples of representative factors which affect the calf intestinal flora are described. Firstly, hygiene of the environments in which calves are born vary place by place. In view of the change from colostrum to milk replacer during the day 4 to 7 after the birth, there are individual differences in a quality and a feed amount of colostrum, and in quality and feed amount of the milk replacer.

Secondly, since the calves are introduced into another breeding farm before the age of 2 weeks after the birth, the calves suffered from stress due to transfer (transportation) and environmental change. Additionally, the breeding farms into which the calves are introduced are different in environmental condition, hygiene, breeding method, and the like.

Thirdly, passive immunity (passive antibodies) of calves is reduced to half in 2 to 3 weeks after the birth. There are individual differences in the reduction in passive immunity. A half life of a calf transferring antibody of IgG is 16 to 32 days; IgM is 4 days; and IgA is 2.5 days (see Non-Patent Publication 1, for example). IgG contributes to immunity of the whole body and intestinal tract, IgM contributes to immunity of prevention of septicemia in newborn calves up to the age of 3 days. IgA contributes to immunity of the mucous surface (local immunity).

Calves start to create antibodies after 2 weeks from the birth to produce active immunity, and the active immunity production is subject to individual difference.

Diseases which are common in calves are digestive diseases of which a main symptom is diarrhea and respiratory diseases of which a main symptom is pneumonia. The calf passive antibodies disappear in 2 to 3 weeks, and it is after 4 weeks from the birth that calves start to create satisfactory antibodies. Infections of calves of shortly after the birth due to insufficient IgG include diarrheal diseases caused by E. coli, rotavirus, coronavirus, cryptosporidia, salmonella, and the like. In a calf group which has a high incidence of pneumonia, diarrhea and insufficient nutrition after the birth as well as a functional loss of T-cells at one month after the birth, which is important for full growth of lymphatic cells, are observed.

Since a sick rate of calves is remarkably high and a death rate thereof frequently exceeds 5%, the sick rate and the death rate weigh down the management. For example, there is a report that 166 out of introduced 300 dairy bulls aging from 5 to 14 days were diagnosed as simple diarrhea (see Non-Patent Publication 2, for example). There is a strong association between the disease, particularly diarrhea, and the death rate.

In view of the above-described circumstances, as an improvement stimulator of intestinal flora for calves, probiotics such as Enterococcus faecalis, Enterococcus faecium, Clostridium butyricum, Bacillus subtilis, Bacillus cereus, Bifidobacterium thermophilium, Bifidobacterium pseudolongum, and Lactobacillus acidophilus and the like and oligosaccharides are commercially available.

However, in the case of the probiotics, it is difficult that the administered probiotics to live in the intestine, and the oligosaccharides have a drawback that it is utilized by many bacteria other than the Bifidobacterium. Therefore, the improvement stimulator of intestinal flora that is capable of specifically increasing only the useful bacterium that can live in the calf intestine for about 2 weeks after the birth has not been found yet.

On the other hand, although Profec (registered trademark: milk whey fermented by Propionibacterium freudenreichii ET-3) which is one of milk whey fermented by Propionibacterium has been known (see Non-Patent Publication 3, for example), there are no findings which confirm an effect obtained by administering the fermented milk whey to newborn domestic animals such as calves. Furthermore, there is no report on the reduction in death rate of newborn domestic animals by preventing diarrhea through formation and establishment of Bifidobacterium flora in the intestine of newborn domestic animals.

Non-Patent Publication 1: Katsurou Hagiwara, Kachiku Shinryou, 47(7), 477 (2000)

Non-Patent Publication 2: Kazuo Suzuki et al., Kachiku Shinryou, No. 256, 19 to 25 (October, 1984)

Non-Patent Publication 3: Nobuo Yoda: ILSI, No. 80, 5 to 13 (2004)

### DISCLOSURE OF THE INVENTION

### Problems to be Solved by the Invention

In view of the present state that the sick rate of newborn domestic animals is high, and that, for example, in the case of calves, the death rate frequently exceeds 5% to weigh down the dairy farming management, an object of the present invention is to decrease the death rate by decreasing the sick rate of newborn domestic animals such as calves, and to breed calves healthy.

More specifically, an object of the present invention is to rapidly and actively create Bifidobacterium flora in the course of formation of a stable intestinal flora after the birth of a newborn domestic animal. Since the newborn domestic animal such as a calf increases Bifidobacterium which are in conformity with physiology of the calf having the Bifidobacterium after the formation of stable intestinal flora, establishment of grown Bifidobacterium is easy after the formation of stable intestinal flora. However, there is no example of a great increase of Bifidobacterium which is achieved by actively forming a favorable intestinal flora after the birth and before natural formation of the intestinal flora.

### Means for Solving the Problems

The present invention has been accomplished for the purpose of attaining the above object. The inventors of the present invention intended to actively form active Bifidobacterium flora after the birth of newborn domestic animals and before natural intestinal flora formation, namely, they intended to form and establish the favorable intestinal flora firstly after the birth.

The present invention has been accomplished to solve the above-described technological problems. As a result of extensive studies, the inventors of the present invention have aimed to solve the problems by a method by oral administration in view of easiness of administration and safety for newborn domestic animals.

Although the intestine of a calf at the birth is in an antiseptic condition, bacteria are established in the intestine via colostrum of a dam and environmental factors (nipple, litter, water, and the like) to form a balanced intestinal flora in 3 weeks after the birth. During this important period, dominance of useful bacteria such as Bifidobacterium is remarkably effective for protecting the calf from diseases during such period. Also, there is a report that the useful bacteria are reduced by aging. The inventors of the present invention have noted the possibility of delaying such bacteria reduction by establishing the dominance of useful bacteria until 3 weeks, more preferably 2 weeks, after the birth and carried out screening on various substances.

The inventors of the present invention carried out screening on fermented milk whey obtained by Propionibacterium as components which are selected from a tremendous number of substances and can form an intestinal flora which is abundant with Bifidobacterium at an earliest possible period after the birth of a newborn domestic animal such as a calf and made further studies to complete the present invention.

Namely, the present invention provides solving means for healthily breeding of newborn domestic animals by forming and establishing Bifidobacterium flora in the intestine of new born domestic animals with administration of fermented milk whey produced by Propionibacterium. The following modes are encompassed by the present invention, for example.

(1) A feed composition comprising milk whey fermented by Propionibacterium.

(2) The feed composition according to the aforementioned (1), which is administered to a newborn domestic animal up to an age of 3 weeks.

(3) The feed composition according to the aforementioned (2), wherein the newborn domestic animal is a calf.

(4) The feed composition according to any one of the aforementioned (1) to (3), which has an intestinal flora improvement activity.

(5) The feed composition according to any one of the aforementioned (1) to (4), wherein the Propionibacterium is Propionibacterium freudenreichii.

(6) The feed composition according to the aforementioned (5), wherein the Propionibacterium is at least one selected from Propionibacterium freudenreichii ATCC 6207, Propionibacterium freudenreichii ATCC 8262, Propionibacterium freudenreichii IFO 12424 (NBRC 12424), Propionibacterium freudenreichii IFO 12426 (NBRC 12426), Propionibacterium freudenreichii IFO 12391 (NBRC 12391), and Propionibacterium freudenreichii ET-3 (FERM BP-8115).

(7) The feed composition according to the aforementioned (6), wherein the Propionibacterium is the Propionibacterium freudenreichii ET-3 (FERM BP-8115).

(8) A method for forming and/or establishing a Bifidobacterium flora in an intestine of a newborn domestic animal, which comprises administering the feed composition described in the aforementioned (1) to a newborn domestic animal.

(9) The method according to the aforementioned (8), wherein the administration is carried out during a period in which the intestinal flora is formed; a period in which passive immunity is reduced; and/or a period with stress.

(10) The method according to the aforementioned (8) or (9), wherein the newborn domestic animal is the new born domestic animal up to an age of 3 weeks.

(11) The method according to the aforementioned (8), wherein the newborn domestic animal is a calf.

(12) The method according to the aforementioned (8), wherein the Propionibacterium is Propionibacterium freudenreichii.

(13) The method according to the aforementioned (12), wherein the propionibacterium is at least one selected from Propionibacterium freudenreichii ATCC 6207, Propionibacterium freudenreichii ATCC 8262, Propionibacterium freudenreichii IFO 12424 (NBRC 12424), Propionibacterium freudenreichii IFO 12426 (NBRC 12426), Propionibacterium freudenreichii IFO 12391 (NBRC 12391), and Propionibacterium freudenreichii ET-3 (FERM BP-8115).

(14) The method according to the aforementioned (13), wherein the Propionibacterium is the Propionibacterium freudenreichii ET-3 (FERM BP-8115).

(15) The method according to the aforementioned (8), wherein the feed composition is administered in an amount in which the feed composition comprises 1,4-dihydroxy-2-naphthoic acid in a range of 2 to 600 μg per day.

(16) The method according to the aforementioned (15), wherein the content of 1,4-dihydroxy-2-naphthoic acid in the feed composition is in a range of 6 to 240 μg.

(17) Use of the feed composition described in the aforementioned (1), for forming and/or establishing Bifidobacterium flora in an intestine of a newborn domestic animal.

(18) The use according to the aforementioned (17), during a period in which the intestinal flora is formed; a period in which passive immunity is reduced; and/or a period with stress.

(19) The use according to the aforementioned (17) or (18), wherein the newborn domestic animal the animal up to an age of 3 weeks.

(20) The use according to the aforementioned (17), wherein the newborn domestic animal is a calf.

(21) The use according to the aforementioned (17), wherein the Propionibacterium is Propionibacterium freudenreichii.

(22) The use according to the aforementioned (21), wherein the Propionibacterium is at least one selected from Propionibacterium freudenreichii ATCC 6207, Propionibacterium freudenreichii ATCC 8262, Propionibacterium freudenreichii IFO 12424 (NBRC 12424), Propionibacterium freudenreichii IFO 12426 (NBRC 12426), Propionibacterium freudenreichii IFO 12391 (NBRC 12391), and Propionibacterium freudenreichii ET-3 (FERM BP-8115).

(23) Use according to the aforementioned (22), wherein the Propionibacterium is the Propionibacterium freudenreichii ET-3 (FERM BP-8115).

(24) The use according to the aforementioned (17), wherein the feed composition is administered in an amount in which the feed composition comprises 1,4-dihydroxy-2-naphthoic acid in a range of 2 to 600 μg per day.

(25) The use according to the aforementioned (24), wherein that the content of 1,4-dihydroxy-2-naphthoic acid in the feed composition is in a range of 6 to 240 μg.

### EFFECT OF THE INVENTION

By oral administration of a feed and/or a feed composition of the present invention to a newborn domestic animal, it is possible to form and further establish a useful Bifidobacterium flora in the intestine of the newborn domestic animal: namely, it is possible to artificially form and establish the useful flora, at time when an intestinal flora has not been formed. Furthermore, as a result, it is possible to reduce and suppress various diseases including diarrhea of newborn domestic animals such as calves to largely reduce a death rate.

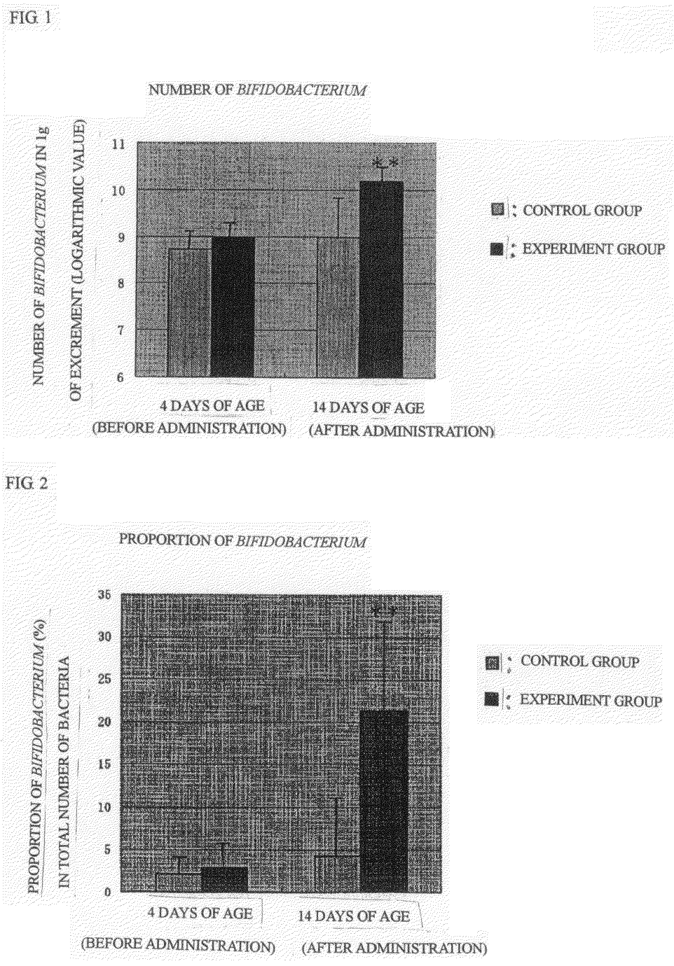

### BRIEF DESCRIPTION OF THE DRAWINGS

[FIG. 1] Number of Bifidobacterium in 1 g of excrement.

[FIG. 2] Proportion of Bifidobacterium in a total number of bacteria.

### BEST MODE FOR CARRYING OUT THE INVENTION

Hereinafter, the present invention will be described in detail.

In the specification, parts, percentages, and proportions which are defined by mass have the same meanings as those defined by weight.

As Propionibacterium to be used in the present invention, a BGS producing probiotic and the like may be used appropriately. A BGS producing probiotic which belongs to Propionibacterium freudenreichii (hereinafter sometimes referred to as P. freudenreichii) may be used. Non-limitative examples of it include P. freudenreichii ATCC 6207, P. freudenreichii ATCC 8262, P. freudenreichii ATCC IFO 12424 (NBRC 12424), P. freudenreichii IFO 12426 (NBRC 12426), and P. freudenreichii IFO 12391 (NBRC 12391), and P. freudenreichii ET-3 (FERM BP-8115) used for Profec is available and usable. The above-listed strains may be used alone or in combination of two or more. Also, preferred examples of the Propionibacterium to be used in the present invention include P. freudenreichii ET-3 (FERM BP-8115).

Examples of a method for culturing the Propionibacterium include a use of a culture medium containing a whey (a content of the whey in the culture medium may preferably be 1 to 20 mass %, more preferably 5 to 15 mass %), an aerobic or anaerobic culture in accordance with the ordinary method (for example, under a nitrogen gas pressurization (0.5 kg/cm²)), and the like. A liquid culture at 20° C. to 40° C. and at a pH level of 6 to 8 may ordinarily be preferred.

In the present invention, milk whey fermented by Propionibacterium is used.

As the milk whey fermented by Propionibacterium, a culture product obtained by culturing Propionibacterium in a culture medium containing milk whey (whey and/or a product thereof treated by protease), an isolated bacterium itself, a culture liquid (culture serum), a mixture thereof, and the like can be used widely. Other than the culture medium containing milk whey described above, a culture medium containing skim milk and the like may be used appropriately. A culture product obtained by culturing Propionibacterium in the culture medium containing the skim milk, an isolated bacterium themselves, a culture liquid (culture serum), a mixture thereof, and the like may be used in place of or in combination with the milk whey fermented by Propionibacterium.

For example, as one example of the milk whey fermented by Propionibacterium, it is possible to use milk whey fermented by Propionibacterium (Profec) which is prepared by fermenting Propionibacterium freudenreichii ET-3 producing a Bifidogenic growth stimulator (BGS) by using whey powder reduction liquid. Although a content of the whey powder of the whey reduction liquid is not particularly limited, it may appropriately be from 1 to 25 wt %. In 100 g of the prepared Profec, 50 μg to 25 mg of 1,4-dihydroxy-2-naphthoic acid (DHNA) is contained.

As Profec to be used in the present invention, those obtained by the ordinary method, commercially available products, and the like may be used.

BGS which is the milk whey fermented by Propionibacterium is 1,4-dihydroxy-2-naphthoic acid (DHNA) and 2-amino-3-carboxy-1,4-naphthoquinone (ACNQ). In these, 1,4-dihydroxy-2-naphthoic acid (DHNA) is a biosynthetic intermediate of vitamin K₂ (menaquinone) in microorganisms. These substances promote growth by effectively re-oxidizing NADH (nicotinamide adenine dinucleotide) generated in the course of energy metabolism of Bifidobacterium.

A dosage of the milk whey fermented by Propionibacterium for a newborn domestic animal is not particularly limited as long as the dosage stimulates formation and establishment of Bifidobacterium flora before natural formation of intestinal flora and after the birth of the newborn calf. It varies depending on a subject for administration, such as a type, a size, a symptom, and the like.

However, it is preferable to use the milk whey fermented by Propionibacterium containing 1,4-dihydroxy-2-naphthoic acid and/or 2-amino-3-carboxy-1,4-naphthoquinone such amounts which stimulates formation and establishment of the Bifidobacterium flora. For example, in the case of 1,4-dihydroxy-2-naphthoic acid, the milk whey fermented by Propionibacterium is administered in a day may preferably contain 1,4-dihydroxy-2-naphthoic acid in an amount of 2 to 600 μg, more preferably 6 to 240 μg. The dosage of the milk whey fermented by Propionibacterium may be divided into plural doses to be administered for plural times and not once, if necessary.

It is possible to administer the milk whey fermented by Propionibacterium prepared as described above as an active ingredient and as it is or as a feed composition which is mixed with an excipient (skim milk, starch, a cereal flour, sugar, and the like). The present feed composition is orally administered to new born domestic animal as a feed together with other feed components (for example, grass hay, grain, oilcake, bran, and the like). For example, it is possible to mix the feed composition of the present invention with milk replacer, a starter, drinking water, or the like to be administered. Since a dosage of the feed composition is remarkably small as described later in this specification, the administration does not impose any burden on the new born domestic animals.

The dosage of the milk whey fermented by Propionibacterium differs depending on the subject for the administration such as the type, the size, and the symptom and the like. For example, in the case of administering the milk whey fermented by Propionibacterium alone to a calf (calf is selected as a representative example of a newborn domestic animal), the dosage per day of the milk whey fermented by Propionibacterium may be from 0.01 to 1200 g, preferably from 0.03 to 480 g. It is possible to administer the milk whey fermented by Propionibacterium in an amount exceeding the range described above in some cases, and the dosage of the milk whey fermented by Propionibacterium may be divided into plural doses to be administered for plural times and not once, if necessary.

In the case of administering a feed composition (hereinafter sometimes referred to as composition containing Profec) obtained by using Profec as the milk whey fermented by Propionibacterium; adding an excipient to Profec; and carrying out a treatment such as freeze-drying, if necessary, to a calf (calf is selected as a representative example of a newborn domestic animal), from 0.04 to 10 g, preferably from 0.1 to 4 g of the feed composition per day may be mixed with a mill replacer and the like and be administered, although the dosage is varied depending on a proportion of the excipient, conditions of freeze-dried and the like, and the like. A remarkably small amount of the feed composition achieves an excellent effect. It is possible to administer the Profec-containing composition in an amount outside the above-specified range in some cases, and the dosage of the milk fermented by Propionibacterium whey may be divided into plural doses to be administered for plural times and not once, if necessary. In the case of using a feed composition containing milk whey fermented by Propionibacterium other than Profec, such feed composition may be administered according to the above-described dosage and the number of doses.

Although a calf is taken as the example the subjects of the present invention in the foregoing description, the subjects of the present invention are not limited thereto. The subjects of the present invention may be mammals (mammals other than human beings is preferable) and birds. Domestic animals such as a cow, a pig, a goat, a horse, a buffalo, and a camel, more preferably newborn domestic animals are more preferable and calves are most preferable. In this connection, although the newborn domestic animals mean those up to and going through a weaning period, there is no problem when the feed composition of the present invention is administered to those that have passed the weaning period or to adult domestic animals.

Although a period for administering the feed composition of the present invention is not particularly limited, it is preferable to administer the feed composition during a period in which a well-balanced intestinal flora is formed, a time period in which passive immunity is decreased, or a time with stress. More specifically, the feed composition of the present invention may preferably be administered not later than 3 weeks from the birth, more preferably not later than 2 weeks from the birth.

### EXAMPLES

Although examples of the present invention will hereinafter be described, the present invention is not limited to the examples.

In the examples, Profec was used as the milk whey fermented by Propionibacterium, and a feed composition (composition containing Profec) obtained by adding an excipient to Profec followed by freeze-drying was used. In 0.4 g of the composition containing Profec, 24 μg of 1,4-dihydroxy-2-naphthoic acid (DHNA) was contained.

### Example 1

### Experiment Schedule

To each of Holstein bull calves which were born in a contract farmer, a sufficient amount of colostrum was fed once immediately after the birth.

The calves were transferred to an experiment farm immediately after the colostrum feeding.

In order to eliminate influences caused by the differences in colostrum as much as possible, a colostrum replacer was administered to the calves from the second suckling to the day 3 after the birth.

After the day 4 after the birth, the colostrum replacer was replaced by a commercially available milk replacer, and the calves were divided into an experiment group and a control group, each consisting of 9 calves.

Each of the colostrum replacer and the commercially available milk replacer was administered in such a manner that 250 g of the colostrum replacer/milk replacer was dissolved into 1.8 L of warm water (45° C.) and the thus-prepared replacer was administered twice a day, namely, in the morning and the evening.

To the experiment group, 0.2 g of the comprising milk whey fermented by Propionibacterium (Profec) was mixed per suckling, i.e. 0.4 g of the Profec-containing composition was mixed and administered per day.

The experiment period was up to the age of 14 days after the birth.

### Experiment Period

(1) At the age of 3 days after the birth (before the start of experiment).

(2) At the age of 14 days after the birth (after the termination of experiment).

### Composition of Colostrum Replacer Used for Experiment

| | |
|---|---|
| Immunoglobulin-rich imported colostrum | 75% |
| powder (skimmed) | |
| Lactose | 6% |
| Vegetable oil | 19% |
| Total | 100% |

Ingredients: 57% of crude protein, 18% of crude fat, 15% of lactose; 15% of immune globulin

### Composition of Commercially Available Milk Replacer Used for Experiment

| | |
|---|---|
| Skim milk | 55% |
| Concentrated whey protein | 20% |
| Vegetable oil | 20% |
| Vitamin and mineral mixture | 5% |
| Total | 100% |

Ingredients: 24% of crude protein, 20% of crude fat, 110% of digestive nutrients total

### Intestinal Flora Improvement Experiment

The calves were divided into experiment groups described below to investigate changes in intestinal flora during each of the experiment periods. The experiment periods were as described above which are Experiment Periods (1) and (2). Bacteria which were subjects for the investigation were the following (A) to (F), and a number of bacterium in 1 g of excrement was counted.

Results obtained by the experiment are shown below, wherein all values show mean values.

### Experiment Group

Experiment group (Profec-fed group)

Control group

### Investigated Bacteria

(A) Bifidobacterium

(B) Lactobacillus

(C) Enterobacteriaceae

(D) Bacteroidaceae

(E) Clostridium, Lecithinase(+)

(F) Clostridium, Lecithinase(−)

(G) Total number of bacterium

### Results

The results are shown in Tables 1 to 3 and FIGS. 1 and 2. Data in each of tables are logarithmic bacterium number in 1 g of excrement, and a detection rate (%) is indicated in brackets. A significant difference between the experiment group and the control group at the age of 14 days was examined (**: p<0.01), (X: 3 days of age (before administration)), (Y: 14 days of age (after administration)).

TABLE 1

| | Experiment Group | | Control Group | |
|---|---|---|---|---|
| | X | Y | X | Y |
| (A) | 8.96 ± 0.47 | 10.19 ± 0.30** | 8.71 ± 0.42 | 8.98 ± 0.95 |
| | (100) | (100) | (100) | (100) |
| (B) | 7.99 ± 1.00 | 8.37 ± 0.68 | 7.83 ± 0.87 | 8.20 ± 0.89 |
| | (100) | (100) | (100) | (100) |
| (C) | 9.68 ± 0.20 | 9.06 ± 0.29** | 9.71 ± 0.24 | 9.14 ± 0.47** |
| | (100) | (100) | (100) | (100) |
| (D) | 10.32 ± 0.39 | 10.75 ± 0.20** | 10.29 ± 0.33 | 10.45 ± 0.53 |
| | (100) | (100) | (100) | (100) |
| (E) | 5.90 ± 0.84 | 3.69 ± 0.86** | 5.53 ± 2.02 | 4.62 ± 2.08 |
| | (100) | (22) | (89) | (78) |
| (F) | 8.06 ± 0.53 | 8.45 ± 0.21 | 8.38 ± 0.67 | 8.47 ± 0.34 |
| | (78) | (22) | (100) | (78) |
| (G) | 10.57 ± 0.27 | 10.92 ± 0.19** | 10.52 ± 0.27 | 10.63 ± 0.50 |
| | n = 9 | n = 9 | n = 9 | n = 9 |

TABLE 2

| | Mean value of number | | | |
|---|---|---|---|---|
| | of bacterium | | Deviation | |
| Number of | Control | Experiment | Control | Experiment |
| Bifidobacterium | group | group | group | group |
| 4 days of age | 8.71 | 8.96 | 0.42 | 0.47 |
| (before | | | | |
| administration) | | | | |
| 14 days of age | 8.98 | 10.19** | 0.95 | 0.30 |
| (after | | | | |
| administration) | | | | |

TABLE 3

| | % | | Deviation | |
|---|---|---|---|---|
| Proportion of | Control | Experiment | Control | Experiment |
| Bifidobacterium | group | group | group | group |
| 4 days of age | 2.1 | 2.9 | 2.35 | 2.94 |
| (before | | | | |
| administration) | | | | |
| 14 days of age | 4.2 | 21.4** | 7.09 | 11.16 |
| (after | | | | |
| administration) | | | | |

As is apparent from the above results, in the experiment group (0.4 g of Profec was administered per day for 10 days), Bifidobacterium in excrement significantly increased (from 8.96 to 10.19 Log 10/g excrement), and the proportion in the total number of bacteria remarkably increased (from 2.9% to 21.4%). On the other hand, a detection rate of lecithinase(+) Clostridium remarkably decreased (from 100% to 22%). As described above, it was confirmed that Profec specifically increases Bifidobacterium in the intestine during the intestinal flora formation period after the birth and is effective for improving the intestinal flora through the in-vivo experiment using actual living calves.

Although the present invention has been described in detail with reference to the specific modes in the foregoing, it is apparent for person skilled in the art that various alterations and modifications are possible as long as the alterations and modifications do not leave from the spirit and scope of the present invention.

The present patent application is based on Japanese Patent Application (Patent Application No.: 2005-079168) filed on Mar. 18, 2005, and contents thereof being incorporated herein by reference.

### INDUSTRIAL APPLICABILITY

By administering the feed and/or the feed composition of the present invention to new born domestic animals, it is possible to form a useful Bifidobacterium flora in the intestine of newborn domestic animals when an intestinal flora is not formed yet and further to establish the formed Bifidobacterium flora, namely, to artificially form and establish the useful flora. Consequently, it is possible to reduce and suppress diseases such as diarrhea of the newborn domestic animals such as calves to decrease a death rate.

1. A feed composition comprising milk whey fermented by Propionibacterium.

2. The feed composition according to claim 1, which is administered to a newborn domestic animal up to an age of 3 weeks.

3. The feed composition according to claim 2, wherein the newborn domestic animal is a calf.

4. The feed composition according to any one of claims 1 to 3, which has an intestinal flora improvement activity.

5. The feed composition according to any one of claims 1 to 4, wherein the Propionibacterium is Propionibacterium freudenreichii.

6. The feed composition according to claim 5, wherein the Propionibacterium is at least one selected from Propionibacterium freudenreichii ATCC 6207, Propionibacterium freudenreichii ATCC 8262, Propionibacterium freudenreichii IFO 12424 (NBRC 12424), Propionibacterium freudenreichii IFO (NBRC 12426), Propionibacterium freudenreichii IFO (NBRC 12391), and Propionibacterium freudenreichii ET-3 (FERM BP-8115).

7. The feed composition according to claim 6, wherein the Propionibacterium is the Propionibacterium freudenreichii ET-3 (FERM BP-8115).

8. A method for forming and/or establishing a Bifidobacterium flora in an intestine of a newborn domestic animal, which comprises administering the feed composition described in claim 1 to a newborn domestic animal.

9. The method according to claim 8, wherein the administration is carried out during a period in which the intestinal flora is formed; a period in which passive immunity is reduced; and/or a period with stress.

10. The method according to claim 8 or 9, wherein the newborn domestic animal is the new born domestic animal up to an age of 3 weeks.

11. The method according to claim 8, wherein the newborn domestic animal is a calf.

12. The method according to claim 8, wherein the Propionibacterium is Propionibacterium freudenreichii.

13. The method according to claim 12, wherein the propionibacterium is at least one selected from Propionibacterium freudenreichii ATCC 6207, Propionibacterium freudenreichii ATCC 8262, Propionibacterium freudenreichii IFO 12424 (NBRC 12424), Propionibacterium freudenreichii IFO 12426 (NBRC 12426), Propionibacterium freudenreichii IFO 12391 (NBRC 12391), and Propionibacterium freudenreichii ET-3 (FERM BP-8115).

14. The method according to claim 13, wherein the Propionibacterium is the Propionibacterium freudenreichii ET-3 (FERM BP-8115).

15. The method according to claim 8, wherein the feed composition is administered in an amount in which the feed composition comprises 1,4-dihydroxy-2-naphthoic acid in a range of 2 to 600 μg per day.

16. The method according to claim 15, wherein the content of 1,4-dihydroxy-2-naphthoic acid in the feed composition is in a range of 6 to 240 μg.

17. Use of the feed composition described in claim 1, for forming and/or establishing Bifidobacterium flora in an intestine of a newborn domestic animal.

18. The use according to claim 17, during a period in which the intestinal flora is formed; a period in which passive immunity is reduced; and/or a period with stress.

19. The use according to claim 17 or 18, wherein the newborn domestic animal the animal up to an age of 3 weeks.

20. The use according to claim 17, wherein the newborn domestic animal is a calf.

21. The use according to claim 17, wherein the Propionibacterium is Propionibacterium freudenreichii.

22. The use according to claim 21, wherein the Propionibacterium is at least one selected from Propionibacterium freudenreichii ATCC 6207, Propionibacterium freudenreichii ATCC 8262, Propionibacterium freudenreichii IFO 12424 (NBRC 12424), Propionibacterium freudenreichii IFO 12426 (NBRC 12426), Propionibacterium freudenreichii IFO 12391 (NBRC 12391), and Propionibacterium freudenreichii ET-3 (FERM BP-8115).

23. Use according to claim 22, wherein the Propionibacterium is the Propionibacterium freudenreichii ET-3 (FERM BP-8115).

24. The use according to claim 17, wherein the feed composition is administered in an amount in which the feed composition comprises 1,4-dihydroxy-2-naphthoic acid in a range of 2 to 600 μg per day.

25. The use according to claim 24, wherein that the content of 1,4-dihydroxy-2-naphthoic acid in the feed composition is in a range of 6 to 240 μg.
